(19) United States
(12) Patent Application Publication
(10) Pub. No.: US 2009/0040666 A1
(43) Pub. Date: Feb. 12, 2009

(54) CIRCUIT INTERRUPTER INCLUDING TEST CIRCUIT

(76) Inventors: ROBERT T. ELMS, Monroeville, PA (US); Kevin L. Parker, Pittsburgh, PA (US); Theodore J. Miller, Oakdale, PA (US)

Correspondence Address: Martin J. Moran, 1000 Cherrington Parkway, Moon Township, PA, 15108, US

(21) Appl. No.: 11/834,935

(22) Filed: Aug. 7, 2007

(51) Int. Cl. H02H 3/16; H02H 3/08

(52) U.S. Cl. 361/42; 361/93.6

(57) ABSTRACT

A circuit interrupter includes separable contacts, a neutral conductor, an operating mechanism structured to open and close the separable contacts, and a plurality of current sensors structured to sense at least current flowing through the separable contacts. Each of the current sensors includes a primary winding and a secondary winding, the primary winding being electrically connected in series with the separable contacts. A trip mechanism is structured to cooperate with the secondary winding of the current sensors and the operating mechanism to trip open the separable contacts. A test circuit tests the current sensors and the trip mechanism. The test circuit is structured to apply a test signal directly to the secondary winding of each of the current sensors.

### BACKGROUND OF THE INVENTION

1. Field of the Invention

This invention pertains generally to circuit interrupters and, more particularly, to arc fault and/or ground fault circuit interrupters including a test circuit.

2. Background Information

Circuit interrupters include, for example, circuit breakers, contactors, motor starters, motor controllers, other load controllers and receptacles having a trip mechanism. Circuit breakers are generally old and well known in the art. Examples of circuit breakers are disclosed in U.S. Pat. Nos. 5,260,676; and 5,293,522.

Circuit breakers are used to protect electrical circuitry from damage due to an overcurrent condition, such as an overload condition or a relatively high level short circuit or fault condition. In small circuit breakers, commonly referred to as miniature circuit breakers, used for residential and light commercial applications, such protection is typically provided by a thermal-magnetic trip device. This trip device includes a bimetal which is heated and bends in response to a persistent overcurrent condition. The bimetal, in turn, unlatches a spring powered operating mechanism which opens the separable contacts of the circuit breaker to interrupt current flow in the protected power system. An armature, which is attracted by the sizable magnetic forces generated by a short circuit or fault, also unlatches, or trips, the operating mechanism.

In many applications, the miniature circuit breaker also provides ground fault protection. Typically, an electronic circuit detects leakage of current to ground and generates a ground fault trip signal. This trip signal energizes a shunt trip solenoid, which unlatches the operating mechanism, typically through actuation of the thermal-magnetic trip device.

A common type of ground fault detection circuit is the dormant oscillator detector including first and second sensor coils. The line and neutral conductors of the protected circuit pass through the first sensor coil. The output of this coil is applied through a coupling capacitor to an operational amplifier followed by a window comparator having two reference values. A line-to-ground fault causes the magnitude of the amplified signal to exceed the magnitude of the reference values and, thus, generates a trip signal. At least the neutral conductor of the protected circuit passes through the second sensor coil. A neutral-to-ground fault couples the two detector coils which causes the amplifier to oscillate, thereby resulting in the generation of the trip signal. See, for example, U.S. Pat. Nos. 5,260,676; and 5,293,522.

Recently, there has been considerable interest in also providing protection against arc faults. Arc faults are intermittent high impedance faults which can be caused, for instance, by worn insulation between adjacent conductors, by exposed ends between broken conductors, by faulty connections, and in other situations where conducting elements are in close proximity. Because of their intermittent and high impedance nature, arc faults do not generate currents of either sufficient instantaneous magnitude or sufficient average RMS current to trip the conventional circuit interrupter. Even so, the arcs can cause damage or start a fire if they occur near combustible material. It is not practical to simply lower the pick-up currents on conventional circuit breakers, as there are many typical loads which draw similar currents and would, therefore, cause nuisance trips. Consequently, separate electrical circuits have been developed for responding to arc faults. See, for example, U.S. Pat. Nos. 5,224,006; and 5,691,869.

For example, an arc fault circuit interrupter (AFCI) is a device intended to mitigate the effects of arc faults by functioning to deenergize an electrical circuit when an arc fault is detected. Non-limiting examples of AFCIs include: (1) arc fault circuit breakers; (2) branch/feeder arc fault circuit interrupters, which are intended to be installed at the origin of a branch circuit or feeder, such as a panelboard, and which may provide protection from ground faults (e.g., greater than 40 mA) and line-to-neutral faults (e.g., greater than 75 A); (3) outlet circuit arc fault circuit interrupters, which are intended to be installed at a branch circuit outlet, such as an outlet box, in order to provide protection of cord sets and power-supply cords connected to it (when provided with receptacle outlets) against the unwanted effects of arcing, and which may provide protection from line-to-ground faults (e.g., greater than 75 A) and line-to-neutral faults (e.g., 5 to 30 A, and greater than 75 A); (4) cord arc fault circuit interrupters, which are intended to be connected to a receptacle outlet, in order to provide protection to an integral or separate power supply cord; (5) combination arc fault circuit interrupters, which function as either a branch/feeder or an outlet circuit AFCI; and (6) portable arc fault circuit interrupters, which are intended to be connected to a receptacle outlet and provided with one or more outlets.

Ground fault protection circuits and arc fault protection circuits typically include separate associated test circuits for affirming their continued operability.

U.S. Pat. No. 5,982,593 discloses a circuit breaker including a ground fault detector, an arc fault detector, and a test mechanism having a ground fault test circuit for testing a ground fault detector trip mechanism, and an arc fault test circuit for testing an arc fault detector trip mechanism. A state machine circuit automatically controls the test mechanism to sequentially test both of the ground fault and arc fault detector trip mechanisms. A test push button is interconnected with the state machine circuit and, when pressed, initiates sequential testing of both of the ground fault and arc fault trip mechanisms. The ground fault test circuit, when enabled by the test controller, generates a test signal to the ground fault detector to simulate a ground fault current condition by mimicking a ground fault and, thereby, testing operation of the ground fault detector. The arc fault test circuit, when enabled by the test controller, provides signals to the arc fault detector to simulate an arc fault current condition by mimicking an arc fault and, thereby, testing operation of the arc fault detector.

The test controller automatically controls the two test circuits to test both of the ground fault detector and the arc fault detector. The single test push button and test controller test both of the ground fault and arc fault trip functions by: (1) inhibiting a trip assembly; (2) enabling one of the two detectors to determine if one of the respective trip signals was generated by the enabled detector; (3) aborting the test if that trip signal was not generated and, otherwise, continuing the test by disabling the enabled detector; and (4) delaying to allow the trip signal to be removed, enabling the trip assembly, and then enabling the other detector. The ground fault detector has a non-latching trip output and is the first enabled detector.

There is a growing belief, particularly regarding ground fault circuit interrupters (GFCIs), that users rarely and inadequately initiate the ground fault self-test function. Hence, there is a need to automate the self-test function in GFCIs and in similar circuit interrupters.

There is room for improvement in circuit interrupters including test circuits.

### SUMMARY OF THE INVENTION

These needs and others are met by embodiments of the invention, which provide a trip mechanism structured to cooperate with the secondary winding of a number of current sensors and the operating mechanism to trip open the separable contacts, and a test circuit for testing the number of current sensors and the trip mechanism, the test circuit being structured to apply a test signal directly to the secondary winding of each of the number of current sensors.

Other embodiments of the invention provide a test circuit structured to periodically test a number of current sensors and at least one of a ground fault analog sensing circuit and an arc fault analog sensing circuit, to activate a number of annunciators responsive to a failure of the periodic test and to cause the trip mechanism to cooperate with the operating mechanism to trip open the separable contacts responsive to the failure of the periodic test, and, otherwise, to maintain the number of annunciators inactive and maintain the separable contacts closed responsive to passage of the periodic test.

Other embodiments of the invention provide a test circuit structured to provide a first test signal to a first current sensor and a first analog sensing circuit to test a first transfer function without causing a ground fault to be detected by a ground fault detector, and a second test signal to a second current sensor and a second analog sensing circuit to test a second transfer function without causing an arc fault to be detected by an arc fault detector, in order to provide both of a first test and a second test before causing the trip mechanism to cooperate with the operating mechanism to trip open the separable contacts.

Applying a “complete system” self-test function to a combination AFCI/GFCI is problematic since it is structured to trip in response to plural unrelated fault conditions (e.g., without limitation, detection of a series arc fault; detection of a parallel arc fault; detection of a ground fault). Hence, for a “complete system” type of self-test, each fault condition would somehow need to be simulated and tested individually. However, passage of any of those self-tests would trip the AFCI/GFCI, thereby precluding the other self-tests.

Other embodiments of the invention provide a test pushbutton and a test circuit structured to provide all of (i) a first test of a first current sensor and a first analog sensing circuit, (ii) a second test of a second current sensor and a second analog sensing circuit, and (iii) a third test of a third current sensor and a third analog sensing circuit, to cause the trip mechanism to cooperate with the operating mechanism to trip open the separable contacts responsive to passage of all of the first test, the second test and the third test, and, otherwise, to maintain the separable contacts closed responsive to failure of at least one of the first test, the second test and the third test.

In accordance with one aspect of the invention, a circuit interrupter comprises: separable contacts; a neutral conductor; an operating mechanism structured to open and close the separable contacts; at least one current sensor structured to sense at least current flowing through the separable contacts, each of the at least one current sensor comprising a primary winding and a secondary winding, the primary winding being electrically connected in series with the separable contacts; a trip mechanism structured to cooperate with the secondary winding of the at least one current sensor and the operating mechanism to trip open the separable contacts; and a test circuit for testing the at least one current sensor and the trip mechanism, the test circuit being structured to apply a test signal directly to the secondary winding of each of the at least one current sensor.

The circuit interrupter may be an arc fault circuit interrupter; the current flowing through the separable contacts may include frequencies greater than about 100 kHz; and the at least one current sensor may be a current transformer structured to sense the current flowing through the separable contacts including the frequencies.

As another aspect of the invention, a circuit interrupter comprises: separable contacts; a neutral conductor; an operating mechanism structured to open and close the separable contacts; at least one current sensor structured to sense at least current flowing through the separable contacts; a trip mechanism comprising at least one of a ground fault analog sensing circuit and an arc fault analog sensing circuit cooperating with the at least one current sensor, the trip mechanism being structured to cooperate with the at least one current sensor and the operating mechanism to trip open the separable contacts; a reset mechanism structured to cooperate with the operating mechanism to close the separable contacts after the operating mechanism trips open the separable contacts; at least one annunciator; and a test circuit structured to periodically test the at least one current sensor and the at least one of the ground fault analog sensing circuit and the arc fault analog sensing circuit, to activate the at least one annunciator responsive to a failure of a periodic test and to cause the trip mechanism to cooperate with the operating mechanism to trip open the separable contacts responsive to the failure of the periodic test, and, otherwise, to maintain the annunciator inactive and maintain the separable contacts being closed responsive to passage of the periodic test.

The test circuit may be further structured to permanently activate the at least one annunciator responsive to failure of the periodic test.

The test circuit may be further structured to periodically test the at least one current sensor and the at least one of the ground fault analog sensing circuit and the arc fault analog sensing circuit about once per day.

The test circuit may be further structured to periodically test both of (i) the ground fault analog sensing circuit and the first current transformer, and (ii) the arc fault analog sensing circuit and the second current transformer; and the test circuit may be further structured to activate a first annunciator responsive to failure of a test of the ground fault analog sensing circuit and the first current transformer and to activate a second annunciator responsive to failure of a test of the arc fault analog sensing circuit and the second current transformer.

As another aspect of the invention, a circuit interrupter comprises: separable contacts; a neutral conductor; an operating mechanism structured to open and close the separable contacts; a first current sensor structured to sense a difference between a current flowing through the separable contacts and a current flowing through the neutral conductor; a first analog sensing circuit cooperating with the first current sensor; a second current sensor structured to sense current flowing through the separable contacts; a second analog sensing circuit cooperating with the second current sensor; a trip mechanism comprising a ground fault detector cooperating with the first analog sensing circuit and an arc fault detector cooperating with the second analog sensing circuit, the trip mechanism being structured to cooperate with the first analog sensing circuit, the second analog sensing circuit and the operating mechanism to trip open the separable contacts; and a test circuit structured to provide both of (i) a first test of the first current sensor and the first analog sensing circuit and (ii) a second test of the second current sensor and the second analog sensing circuit, and to cause the trip mechanism to cooperate with the operating mechanism to trip open the separable contacts responsive to failure of at least one of the first test and the second test, and, otherwise, to maintain the separable contacts being closed responsive to passage of both of the first test and the second test, wherein the first current sensor and the first analog sensing circuit have a first transfer function, wherein the second current sensor and the second analog sensing circuit have a second transfer function, and wherein the test circuit is further structured to provide a first test signal to the first current sensor and the first analog sensing circuit to test the first transfer function without causing a ground fault to be detected by the ground fault detector, and a second test signal to the second current sensor and the second analog sensing circuit to test the second transfer function without causing an arc fault to be detected by the arc fault detector, in order to provide both of the first test and the second test before causing the trip mechanism to cooperate with the operating mechanism to trip open the separable contacts.

The current flowing through the separable contacts may have a first frequency; the first test signal may have a second frequency, which is one-half of the first frequency; and the test circuit may be further structured to input a first signal from the first analog sensing circuit and determine if the first signal is less than a negative predetermined value in order to pass the first test.

The first current sensor may be a current transformer including a coil; the test circuit may be further structured to input a second signal from the first analog sensing circuit and determine if the second signal is greater than a positive predetermined value in order to confirm that the coil is continuous and to pass the first test.

The current flowing through the separable contacts may have a first line frequency; the second test signal may have a second frequency, which is substantially greater than the first line frequency and which is greater than about 100 kHz; and the test circuit may be further structured to input a third signal from the second analog sensing circuit and determine if the third signal is greater than a positive predetermined value in order to pass the second test.

As another aspect of the invention, a circuit interrupter comprises: separable contacts; a neutral conductor; an operating mechanism structured to open and close the separable contacts; a first current sensor structured to sense a difference between a current flowing through the separable contacts and a current flowing through the neutral conductor; a first analog sensing circuit cooperating with the first current sensor; a second current sensor structured to sense current flowing through the separable contacts; a second analog sensing circuit cooperating with the second current sensor; a third current sensor structured to sense current flowing through the separable contacts; a third analog sensing circuit cooperating with the third current sensor; a trip mechanism comprising a ground fault detector, a parallel arc fault detector and a series arc fault detector; a test pushbutton; and a test circuit structured to provide all of (i) a first test of the first current sensor and the first analog sensing circuit, (ii) a second test of the second current sensor and the second analog sensing circuit, and (iii) a third test of the third current sensor and the third analog sensing circuit, to cause the trip mechanism to cooperate with the operating mechanism to trip open the separable contacts responsive to passage of all of the first test, the second test and the third test, and, otherwise, to maintain the separable contacts being closed responsive to failure of at least one of the first test, the second test and the third test.

### BRIEF DESCRIPTION OF THE DRAWINGS

A full understanding of the invention can be gained from the following description of the preferred embodiments when read in conjunction with the accompanying drawings in which:

FIG. 1 is a block diagram in schematic form of a circuit interrupter in accordance with embodiments of the invention.

FIG. 2 is a block diagram in schematic form of a circuit to generate the line current test signal by the microprocessor of FIG. 1.

FIG. 3 is a flowchart of a routine executed by the microprocessor of FIG. 1 to process a manual self-test request.

FIGS. 4A-4E form a flowchart of main, interrupt and self-test routines executed by the microprocessor of FIG. 1 to perform the manually requested self-test.

FIG. 5 is a plot of the transfer function of the ground fault sensor and ground fault analog sensing circuit in accordance with an embodiment of the invention.

FIG. 6 is a flowchart of a routine executed by the microprocessor of FIG. 1 to provide a periodic self-test request.

FIG. 7 is a flowchart of a portion of a routine executed by the microprocessor of FIG. 1 to perform the periodically requested self-test.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

The invention is described in association with an arc fault/ground fault circuit breaker, although the invention is applicable to a wide range of circuit interrupters.

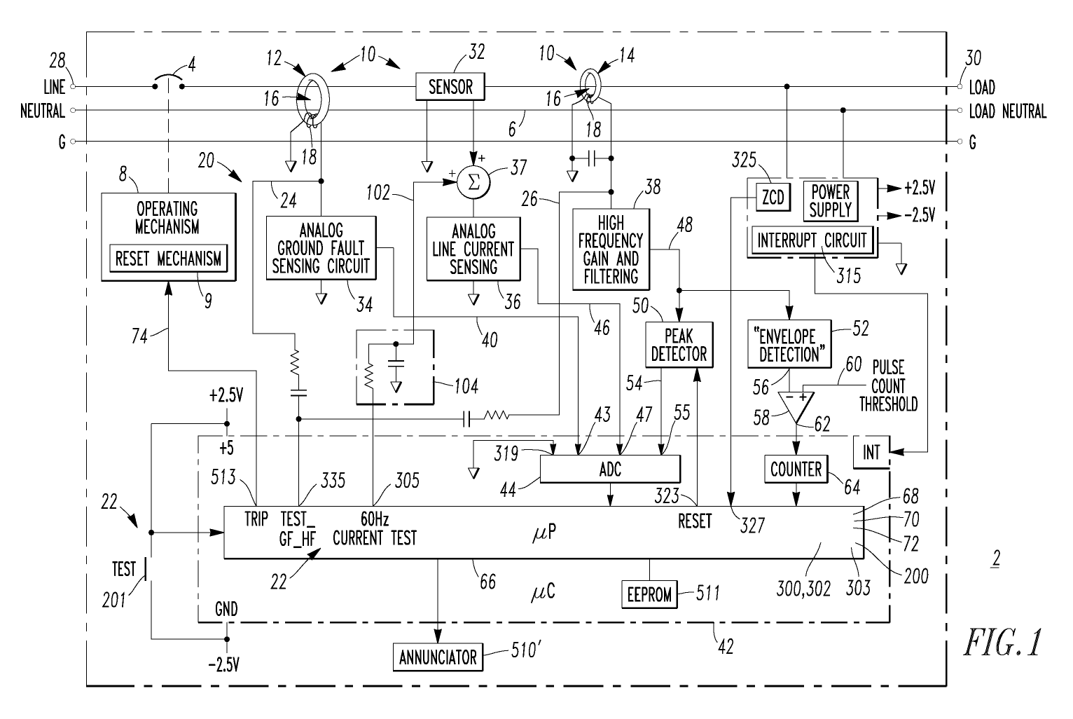

Referring to FIG. 1, a circuit interrupter (e.g., without limitation, such as ground fault circuit interrupter/arc fault circuit interrupter 2) includes separable contacts 4, a neutral conductor 6, and an operating mechanism 8 structured to open and close the separable contacts 4. A number of current sensors 10 are structured to sense at least current flowing through the separable contacts 4. Each of the current sensors 12,14 includes a primary winding 16 and a secondary winding 18. The primary winding 16 is electrically connected in series with the separable contacts 4. A trip mechanism 20 is structured to cooperate with the secondary windings 18 and the operating mechanism 8 to trip open the separable contacts 4. Preferably, the operating mechanism 8 includes or cooperates with a suitable reset mechanism 9, which is structured to cooperate with the operating mechanism 8 to close the separable contacts 4 after the operating mechanism 8 trips open the separable contacts 4. A test circuit 22 tests the current sensors 10 and the trip mechanism 20 and is structured to apply stimulus test signals 24,26 directly to the secondary windings 18 of the current sensors 12,14, and a test signal 102 to a summer 37 at the output of current sensor 32. This advantageously allows the stimulus test signals 12,14 to be several orders of magnitude (i.e., as reduced by the turns ratio of the current sensors 12,14) lower than that needed at the primary winding 16. For example, injecting relatively high frequency current signals onto a power line can be in violation of FCC rules if this exceeds FCC limits, which are typically lower than the values used for arc fault detection.

For example, for ground fault detection, the current sensor 12 is a current transformer structured to sense a difference between the current flowing through the separable contacts 4 from the line terminal 28 to the load terminal 30 and a current flowing through the neutral conductor 6. Also, for series arc fault detection, the current sensor 14 is a current transformer structured to sense the current flowing through the separable contacts 4. For purposes of series arc fault detection, that current includes frequencies greater than about 100 kHz, and the current sensor 14 is structured to sense that current including those frequencies. The other current sensor 32 is a suitable shunt structured to sense the current flowing through the separable contacts 4 for purposes of parallel arc fault detection.

An analog ground fault sensing circuit 34 cooperates with the current sensor 12, an analog line current sensing circuit 36 and the summer 37 cooperate with the current sensor 32, and an analog series arc fault sensing circuit 38, which provides high frequency gain and filtering, cooperates with the current sensor 14. The analog ground fault sensing circuit 34 outputs a sensed signal 40 to a microcomputer (μC) 42 and, in particular, to channel 43 of analog-to-digital converter (ADC) 44 thereof. The analog line current sensing circuit 36 outputs a sensed signal 46 to channel 47 of the μC ADC 44. The analog series arc fault sensing circuit 38 outputs a sensed signal 48 to a peak detector circuit 50 and to an envelope detection circuit 52. The peak detector circuit 50 outputs a peak signal 54 to channel 55 of the μC ADC 44. The output 56 of the envelope detection circuit 52 is input by the negative input of a comparator 58, which uses a reference (PULSE COUNT THRESHOLD) 60 at its positive input. The output 62 of the comparator 58 is input by a counter 64 of the μC 42.

The μC 42 includes a microprocessor (μP) 66 having routines 68, 70 and 72 that respectively provide a ground fault detector cooperating with the analog ground fault sensing circuit 34, a parallel arc fault detector cooperating with the analog line current sensing circuit 36, and a series arc fault detector cooperating with the analog series arc fault sensing circuit 38 through the peak detector circuit 50, the envelope detection circuit 52, the comparator 58 and the counter 64.

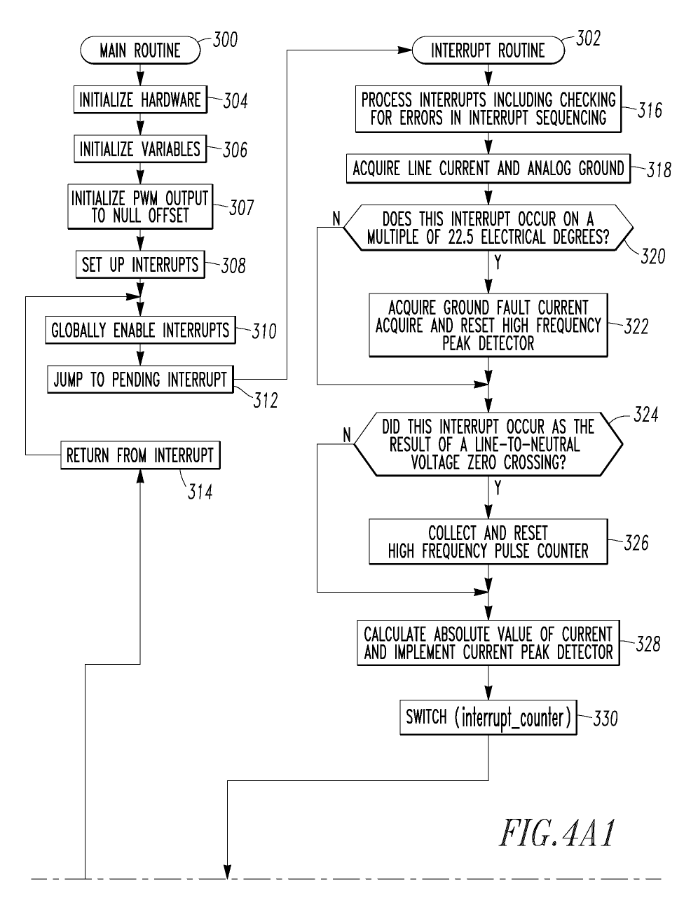

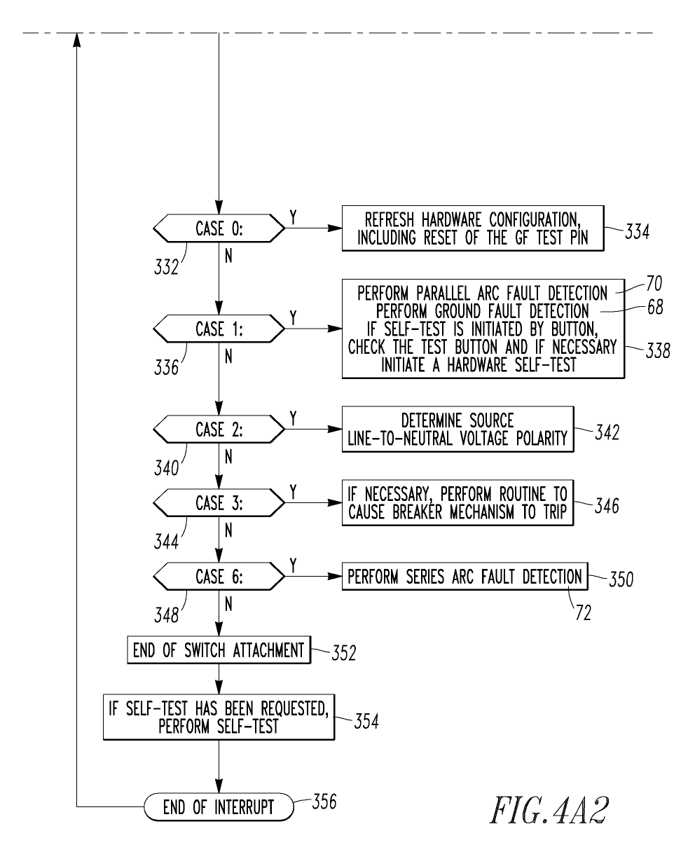

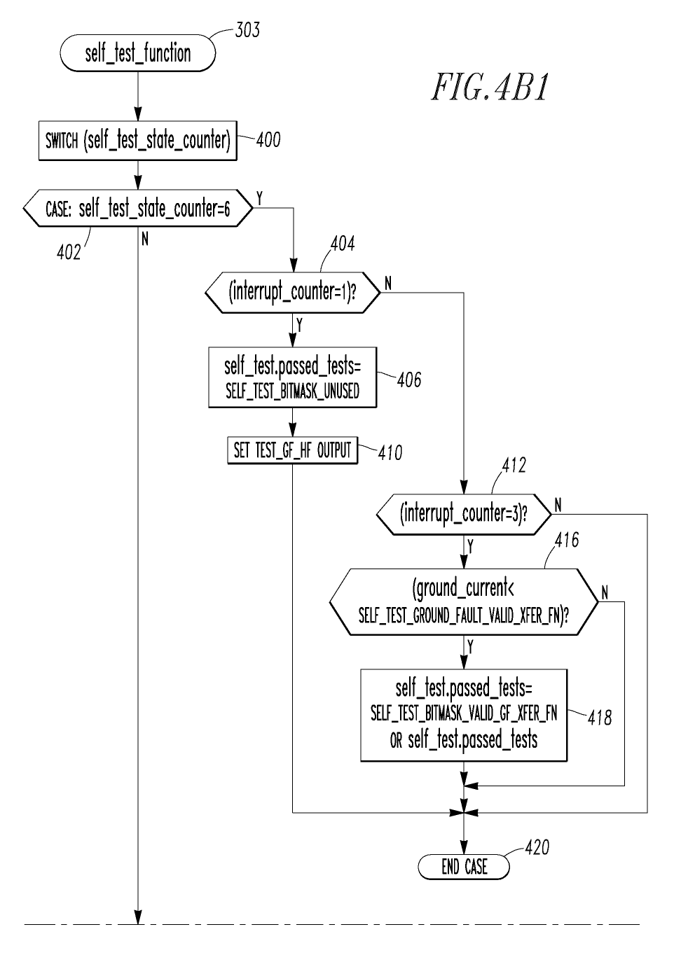

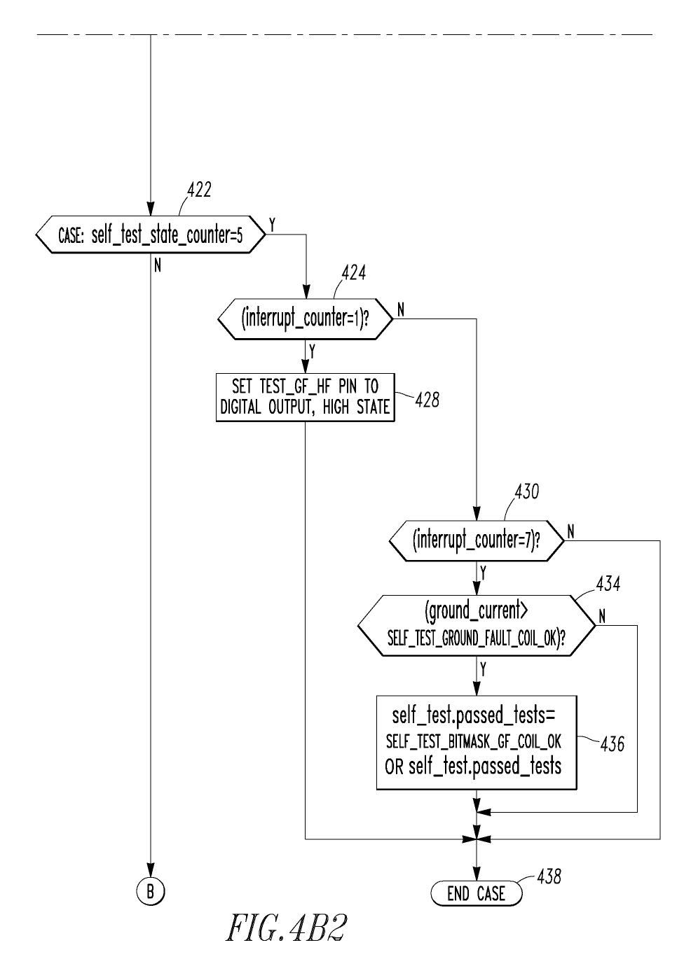

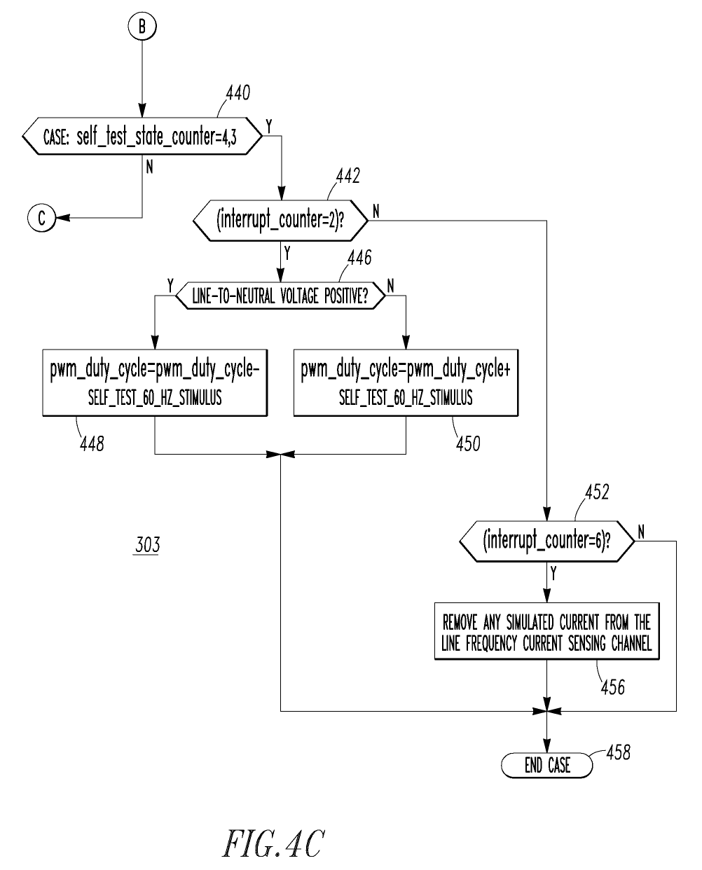

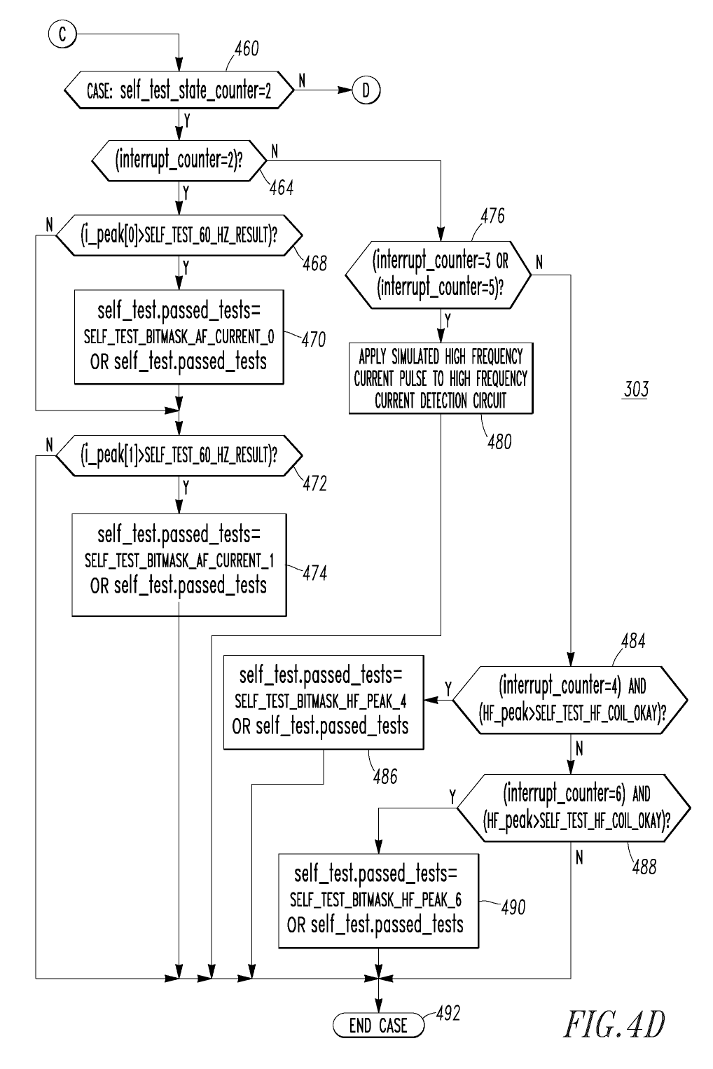

As will be described, below, in connection with FIGS. 4A-4E, the test circuit 22 is structured to provide both of (i) a first test of the current sensor 12 and the analog ground fault sensing circuit 34 and (ii) a second test of the current sensor 14 and the analog series arc fault sensing circuit 38, and to cause the trip mechanism 20 to cooperate with the operating mechanism 8 to output a trip signal 74 and trip open the separable contacts 4 responsive to failure of at least one of the first test and the second test, and, otherwise, to maintain the separable contacts 4 closed responsive to passage of both of the first test and the second test.

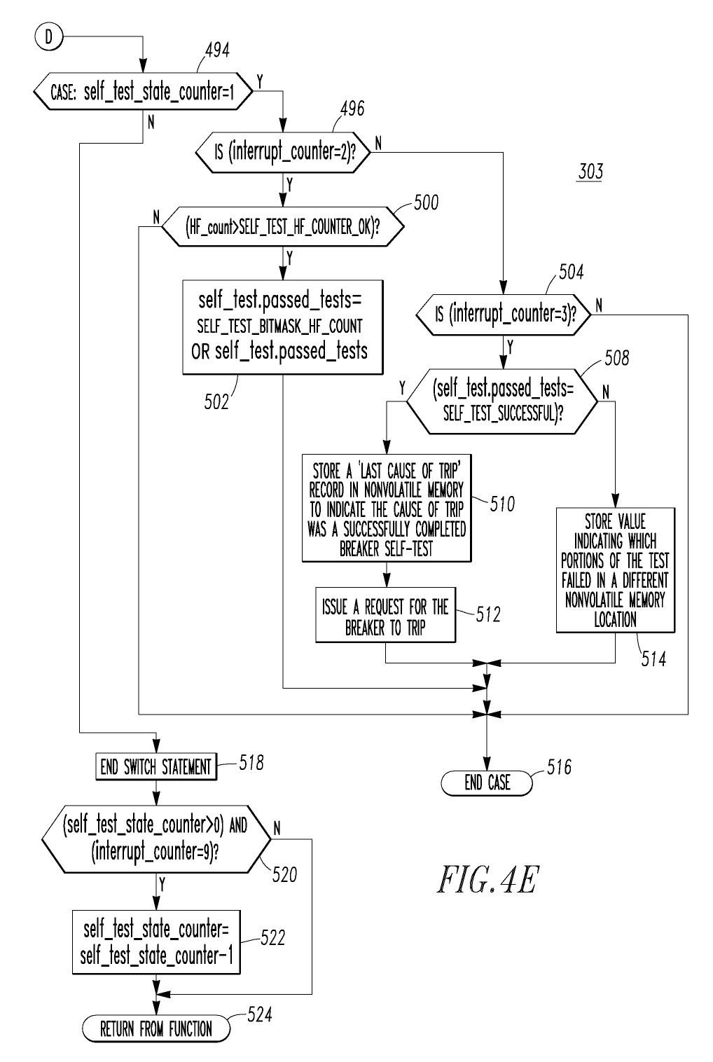

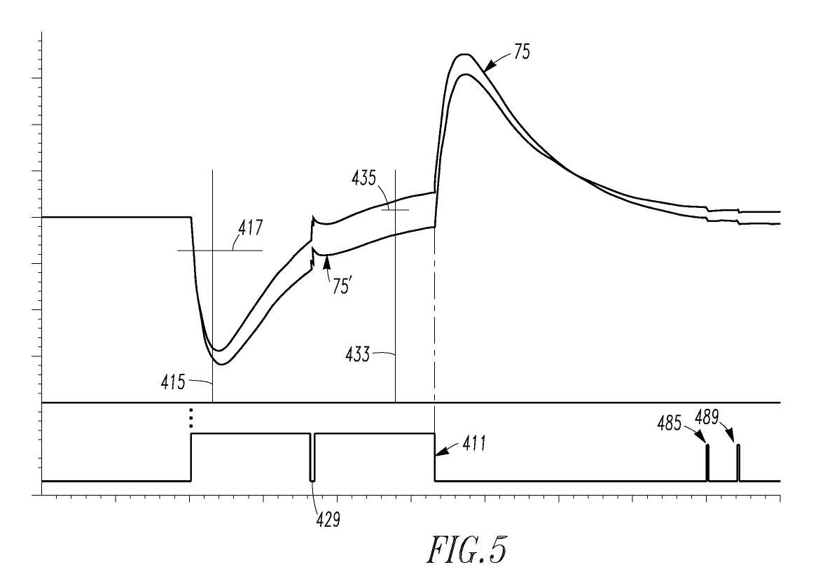

The current sensor 12 and the analog ground fault sensing circuit 34 have a first transfer function 75 as will be discussed, below, in connection with FIG. 5. Also, the current sensor 14 and the analog series arc fault sensing circuit 38 have a second transfer function. The test circuit 22 is further structured to provide the test signal 24 to the current sensor 12 and the analog ground fault sensing circuit 34 to test the first transfer function without causing a ground fault to be detected by the ground fault detector routine 68. The test circuit 22 is also structured to provide the test signal 26 to the current sensor 14 and the analog series arc fault sensing circuit 38 to test the second transfer function (e.g., without limitation, resulting from high frequency resonance of the current sensor 14) without causing an arc fault to be detected by the series arc fault detector routine 72.

As a non-limiting example, the current sensor 14 may be structured to resonate at a certain frequency. The circuit 38 may be structured to convert the current output of the current sensor 14 to a voltage signal by a first op-amp circuit (not shown), which is then filtered by a second op-amp circuit (not shown). Hence, the combined circuit 14,38 could mis-operate in several ways: (1) the sensing coil (secondary winding 18) could be an open-circuit; (2) the coil center frequency or output at resonance could be out-of-tolerance; (3) the gain of the first op-amp circuit could be out-of-tolerance; and (4) the filter characteristics of the second op-amp circuit could be out-of-tolerance. This self-test is structured to stimulate the high frequency sensing coil at or near its resonant frequency, measure the total circuit response at the μP 66, and detect any of these failure modes, which could occur either individually or in combination.

Hence, by injecting the test signals 24,26 directly to the secondary windings 18 and below the corresponding fault detection levels of the routines 68,72, this permits the test circuit 22 to evaluate the transfer function gain of the first and second transfer functions, rather than causing a direct trip. This advantageously permits both of the first test and the second test to be conducted before causing the trip mechanism 20 to cooperate with the operating mechanism 8 to trip open the separable contacts 4. For example, fault detection usually involves detection of a fault condition, which persists for some period of time. In order to prevent tripping on the test signals 24,26, these signals could either fail to meet the fault condition criteria or persist for less than the specified trip time period, or both. Hence, this permits the evaluation of multiple functions.

As will be seen, below, in connection with FIGS. 4A-4E, the trip mechanism 20 includes the ground fault detector routine 68, the parallel arc fault detector routine 70 and the series arc fault detector routine 72. The test circuit 22 is structured to respond to the test pushbutton 201 and provide all of (i) a first test of the current sensor 12 and the analog ground fault sensing circuit 34, (ii) a second test of the current sensor 32 and the analog line current sensing circuit 36, and (iii) a third test of the current sensor 14 and the high frequency gain and filtering circuit 38, to cause the trip mechanism 20 to cooperate with the operating mechanism 8 to trip open the separable contacts 4 responsive to passage of all of this first test, second test and third test, and, otherwise, to maintain the separable contacts 4 closed responsive to failure of at least one of such first test, second test and third test. This sequentially evaluates plural different protective functions (i.e., in this example, ground fault, parallel arc fault and series arc fault) with the single test pushbutton 201, and requires all of these protective functions to be good before the self-test is completed with a positive indication (i.e., tripping the circuit interrupter 2).

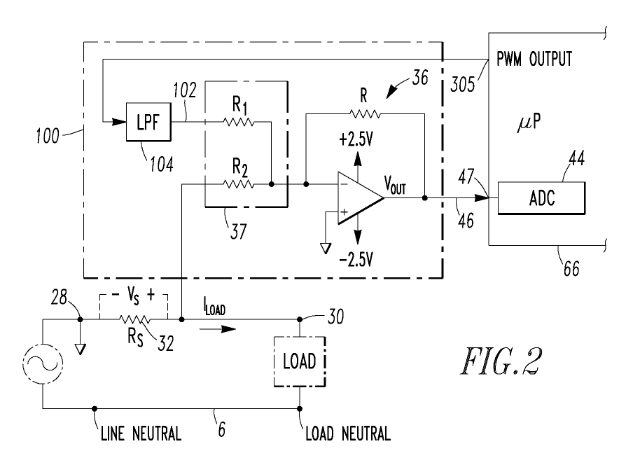

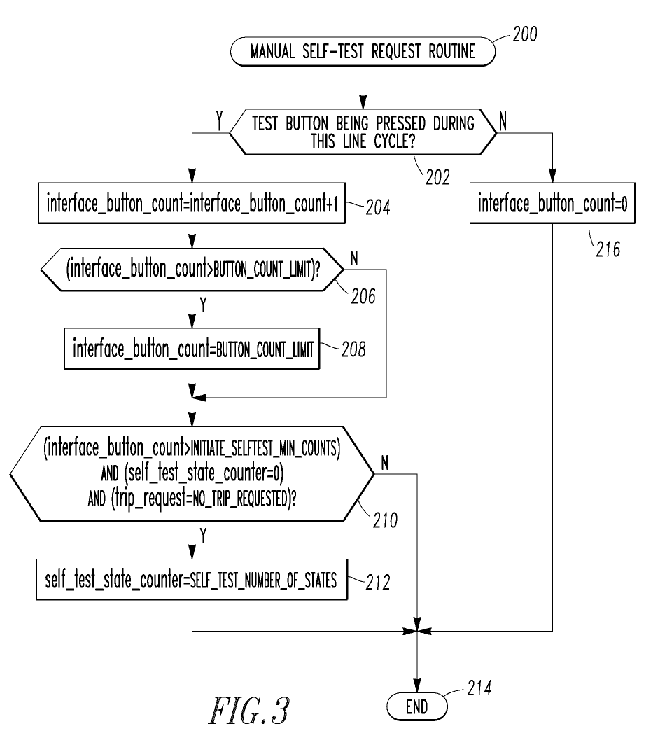

FIG. 2 shows a circuit 100 to generate the line current test signal 102 from the μP 66 of FIG. 1 and to output the sensed signal 46 to the μP 66. The circuit 100 includes a low pass filter (LPF) 104, the summer 37 and the analog line current sensing circuit 36 of FIG. 1. A pulse width modulated (PWM) digital output 305 of the μP 66 is structured to provide a duty cycle “d” of, for example, 0.0, 0.25, 0.5, 0.75, or 1.0, where, for example, d=0 is “low” or −2.5 V, d=1 is “high” or +2.5 V, d=0.25 is a series of pulses that are “high” 25% of the time and “low” 75% of the time, d=0.5 is a series of pulses that are “high” 50% of the time and “low” 50% of the time, and d=0.75 is a series of pulses that are “high” 75% of the time and “low” 25% of the time. As such, the voltage of the line current test signal 102 as output by LPF 104 is, for example, for d=0.0: a DC signal of −2.5 V, for d=0.25: a DC signal of −1.25 V, for d=0.5: a DC signal of 0.0 V, for d=0.75: a DC signal of +1.25 V, and for d=1.0: a DC signal of +2.5 V.

The transfer function of the circuit 36 is defined by Equations 1 and 2:

V_{S}=I_{LOAD}*R_{S} (Eq. 1)

wherein:
V_{S} is voltage across the current sensor 32;
I_{LOAD} is load current or current flowing through the current sensor 32; and
R_{S} is resistance of the current sensor 32 (e.g., without limitation, a resistive shunt).

V_{OUT}=−(I_{LOAD}*R_{S})*(R/R₂)−(5d−2.5)*(R/R₁) (Eq. 2)

wherein:
R, R₁ and R₂ are resistances of the circuit 36; and
d is the duty cycle of the PWM output 305 (e.g., 0≦d≦1).

The circuit 100 advantageously permits the μP 66 to control the test signal 102 without employing a digital to analog converter.

FIG. 3 shows a routine 200 executed by the μP 66 of FIG. 1 to process a manual self-test request from the test pushbutton 201. The routine 200 is preferably executed once per line cycle of the line-to-neutral voltage (e.g., as measured between the load terminal 30 and the neutral conductor 6). First, at 202, it is determined if the test pushbutton 201 is being pressed during the current line cycle. If so, then a variable (interface_button_count) is incremented at 204. Next, at 206, it is determined if the variable (interface_button_count) is greater than a maximum allowed value (BUTTON_COUNT_LIMIT) (e.g., without limitation, 240; 4 seconds at a 60 Hz line frequency). If so, then at 208, the variable (interface_button_count) is set equal to the maximum allowed value (BUTTON_COUNT_LIMIT). Otherwise, or after 208, at 210, it is determined if the variable (interface_button_count) is greater than a predetermined amount (INITIATE_SELFTEST_MIN_COUNTS) (e.g., without limitation, 60; one second at a 60 Hz line frequency), there is no self-test currently in progress and there is no trip request currently pending. If so, then, at 212, a self-test is requested by setting a variable (self_test_state_counter) to a suitable predetermined value (SELF_TEST_NUMBER_OF_STATES) (e.g., without limitation, six). After 212, or if the test failed at 210, the routine 200 ends at 214. If the test failed at 202, then, at 216, the variable (interface_button_count) is set to zero before the routine 200 ends at 214.

FIG. 4A is a flowchart of a main routine 300 and an interrupt routine 302 executed by the μP 66 of FIG. 1 to perform the manually requested self-test routine (self_test_function) 303 of FIGS. 4B-4E. First, the main routine 300 initializes hardware, at 304, initializes variables, at 306, initializes the PWM output 305 (FIGS. 1 and 2) to a null offset, at 307, and sets up interrupts, at 308. Next, at 310, interrupts are globally enabled, after which a jump to a pending interrupt of the interrupt routine 302 is taken at 312. After the interrupt routine 302 is executed, the return from interrupt occurs at 314, after which step 310 is repeated. The ten interrupts (0 through and including 9) from an interrupt circuit 315 (FIG. 1) preferably occur at the following electrical angles, synchronous with and relative to the zero crossing of the line-to-neutral voltage: 0°, +11.25°, +22.5°, +45°, +67.5°, +90°, +112.5°, +135°, +157.5° and +168.75°.

In the interrupt routine 302, at 316, interrupts are processed including checking for errors in interrupt sequencing. Next, at 318, the line current and analog ground are acquired by reading the ADC channel corresponding to ADC input 47 (FIG. 1). Because of the alternating current (AC) line-to-neutral voltage, the AC line current may at any time exhibit either positive or negative polarity. Knowledge of the polarity of the AC line current facilitates, for example, determination of displacement power factor, which can be useful in identifying loads with inductive impedance characteristics and differentiating such loads from parallel arc faults.

One technique for sensing the AC line current is to use a linear analog circuit (not shown), which produces a voltage that is proportional to and preserves the polarity of the AC line current. When the example μP 66 processes this current information, an additional mechanism is needed to convert the current-proportional voltage signal into a digital format.

One particular technique for sensing AC line current is to use a suitable analog circuit with positive and negative power supplies to sense the current and to drive a bipolar analog-to-digital converter, which can convert analog voltage signals of either positive or negative polarity into digital numbers of corresponding polarity.

As an alternative technique, a suitable analog current sensing circuit with a single polarity voltage supply (e.g., 0 VDC to +5 VDC) can be used, in which the analog circuitry is referenced to a “virtual analog ground” midway between the rails of the single polarity voltage supply (e.g., at about +2.5 VDC). The output of the analog current sensing circuit, such as 36, can be used to drive one channel of a multichannel unipolar analog-to-digital converter, such as 44, which converter is integrated into the μC 42. The “virtual analog ground” is sampled by an additional channel 319 of the unipolar ADC 44. Then, the μP 66 derives a digital number proportional to the current and with the correct current polarity by calculating the difference between the sampled value of the analog current sensing circuit 36 and the sampled value of the “virtual analog ground”.

Next, at 320, it is determined if the present interrupt occurs on a multiple of 22.5°. If so, then at 322 the ground fault current is acquired by reading the ADC channel corresponding to ADC input 43 (FIG. 1), the high frequency peak detector signal 54 is acquired by reading the ADC channel corresponding to ADC input 55, and the peak detector 50 is reset by μP output 323. Otherwise, or after 322, at 324, it is determined if the present interrupt occurs as a result of a line-to-neutral voltage zero crossing.

A line-to-neutral voltage zero crossing detector (ZCD) 325 (FIG. 1) generates a digital square wave output whose transitions occur in response to the zero crossings of the line-to-neutral voltage. The square wave output of the ZCD 325 drives an “interrupt-on-state-change” input 327 of the μC 42. By reading the source of interrupt (e.g., either internal timer or external state change), the μP 66 knows whether the interrupt was the result of a line-to-neutral voltage zero crossing. Also, the value of the ZCD input 327 is read to determine the polarity of the line-to-neutral voltage.

If there was a line-to-neutral voltage zero crossing interrupt at 324, then the counter 64 (FIG. 1) for counting high frequency pulses is read and reset at 326. Otherwise, or after 326, at 328, the absolute value of the current read at 318 is calculated and a current peak detector is implemented. At 318, an algorithm tracks the maximum absolute value of line current, which occurred since the immediately preceding line-to-neutral voltage zero crossing. This derives the variables “i_peak(0)” and “i_peak(1)”, which are the peak currents that occurred during a given half-cycle of line-to-neutral voltage.

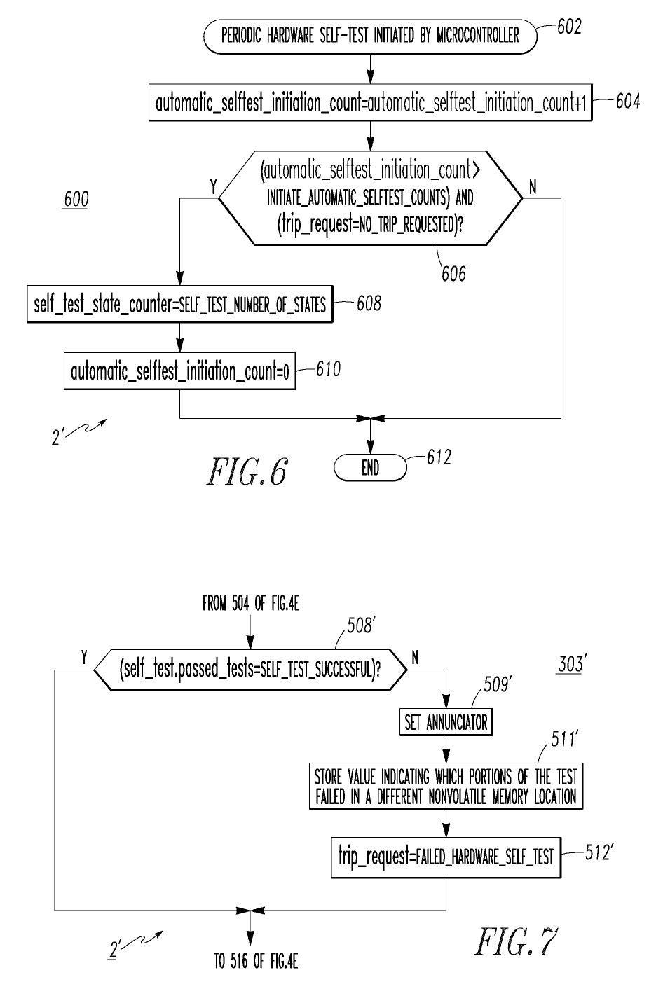

Next, at 330, a switch statement is executed in order to direct further execution based upon the value of the variable (interrupt_counter), which corresponds to the ten interrupts as were discussed above. If case 332 determines that the variable (interrupt_counter) is zero, then, at 334, the hardware configuration is refreshed including a reset of output 335 (TEST_GF_HF) (FIG. 1) (to a low or inactive state) for testing of ground faults (and for testing of series arc faults). Otherwise, if the variable (interrupt_counter) is not zero, and if case 336 determines that the variable (interrupt_counter) is one, then, at 338, the parallel arc fault detector routine 70 is executed, the ground fault detector routine 68 is executed, and if a self-test is initiated by the pushbutton 201 (FIG. 1), then the routine 200 of FIG. 3 is executed to check the pushbutton 201 and, if necessary, set the variable (self_test_state_counter) to initiate the hardware self-test. Alternatively, if the self-test is initiated by a counter/timer in connection with FIG. 6, then the counter/timer is checked and the variable (self_test_state_counter) is set to initiate the hardware self-test. Otherwise, if the variable (interrupt_counter) is not one, and if case 340 determines that the variable (interrupt_counter) is two, then, at 342, the source line-to-neutral polarity is determined, as was discussed above in connection with step 324. Otherwise, if the variable (interrupt_counter) is not two, and if case 344 determines that the variable (interrupt_counter) is three, then, at 346, if necessary, a suitable routine is executed to cause the operating mechanism 8 to trip by setting the trip signal 74 (e.g., in response to the request of step 512 of FIG. 4E). Otherwise, if the variable (interrupt_counter) is not three, and if case 348 determines that the variable (interrupt_counter) is six, then, at 350, the series arc fault detector routine 72 is executed. Next, at 352, the switch statement of step 330 ends. Then, at 354, the self-test is performed if requested at 338. Finally, the interrupt ends at 356, which causes execution to resume at 314.

Referring to FIG. 4B, the manually requested self-test routine 303 is shown. This routine 303 creates test stimuli and measures the resulting response for the following hardware elements of FIG. 1: (1) ground fault current sensing: verify the operation of the analog ground fault sensing circuit 34, the corresponding transfer function of the current sensor 12 and the circuit 34, and the continuity (coil continuity) of the coil (secondary winding 18) of the current sensor 12; (2) parallel arc fault current sensing: verify the operation of the analog parallel arc fault line current sensing circuit 36 and the validity of the corresponding transfer function thereof; and (3) series arc fault high frequency current sensing: verify the operation of the analog series arc fault sensing circuit 38, the corresponding transfer function of the current sensor 14 (e.g., without limitation, a current transformer structured to resonate in response to frequencies greater than about 100 kHz; about 1 MHz), the circuit 38, the peak detector 50 and the envelope detection circuit 52, and the continuity (coil continuity) of the coil (secondary winding 18) of the current sensor 14. In this manually requested self-test routine 303, actions are sequenced based upon the variable (self_test_state_counter) of FIG. 3, which, for example, decrements once per line half-cycle from six to zero, as monitored by the switch (self_test_state_counter) at 400.

The variable (self_test_state_counter), which ranges from six to zero, and the variable (interrupt_counter), which ranges from zero to 9, define a test cycle over six (when self_test_state_counter equals zero, execution of the self-test routine 303 is bypassed) half-cycles of the line-to-neutral voltage. If case 402 determines that the variable (self_test_state_counter) is six, then, at 404, it is determined if the variable (interrupt_counter) is one. If so, then, at 406, a variable (self_test.passed_tests) is initialized to a predetermined value (SELF_TEST_BITMASK_UNUSED) (e.g., without limitation, 0b10000000 or only bit 7 is true). Next, the first part of the ground fault sensing self-test is executed by setting the output (TEST_GF_HF) 335 true at 410. Although this output 335 is used by both the ground fault sensing self-test and the series arc fault sensing self-test, here, the output 335, as will be described, essentially provides a relatively low frequency (e.g., without limitation, 30 Hz for a 60 Hz line frequency) signal 411 (FIG. 5) in this portion of the self-test and has an insignificant impact on the high frequency gain and filtering circuit 38 (FIG. 1).

Otherwise, if the test failed at 404, then at 412, it is determined if the variable (interrupt_counter) is three. If so, then the first part of the ground fault sensing self-test is verified at time 415 (FIG. 5) by testing, at 416, if the ground fault transfer function is acceptable. FIG. 5 shows the normal transfer function 75 of the ground fault current sensor 12 and the ground fault analog sensing circuit 34 when the secondary winding 18 of the current sensor 12 is continuous. However, when that secondary winding 18 is discontinuous, another transfer function, such as 75′ (FIG. 5), results. The normal transfer function 75 is determined if the sensed signal 40 from the output of the analog ground fault sensing circuit 34 is less than a predetermined threshold (SELF_TEST_GROUND_FAULT_VALID_XFER_FN) 417 (FIG. 5) (e.g., without limitation, −0.366 V). If so, then, at 418, the variable (self_test.passed_tests) is ORed with a predetermined value (SELF_TEST_BITMASK_VALID_GF_XFER_FN) (e.g., without limitation, 0b01000000 or only bit 6 is true) to indicate successful completion of this sub-test. If the test failed at 412, or after 410 or 418, then the case ends at 420.

If the test failed at 402, then at 422, it is determined if the variable (self_test_state_counter) is five. If so, then at 424, it is determined if the variable (interrupt_counter) is one. If so, then the second part of the ground fault sensing self-test is executed by setting the output (TEST_GF_HF) 335 true at 428. This output was momentarily reset low (as shown at time 429 of FIG. 5) at 334 of FIG. 4A for the case when the variable (interrupt_counter) was zero.

Otherwise, if the test failed at 422, then execution resumes at 440 of FIG. 4C. If the test failed at 424, then at 430, it is determined if the variable (interrupt_counter) is seven. If so, then the second part of the ground fault sensing self-test is verified at time 433 (FIG. 5) by testing, at 434, if the secondary winding 18 of the current sensor 12 is continuous. This is determined if the sensed signal 40 from the output of the analog ground fault sensing circuit 34 is greater than a predetermined threshold (SELF_TEST_GROUND_FAULT_COIL_OK) 435 (FIG. 5) (e.g., without limitation, +0.050 V). If so, then, at 436, the variable (self_test.passed_tests) is ORed with a predetermined value (SELF_TEST_BITMASK_GF_COIL_OK) (e.g., without limitation, 0b00100000 or only bit 5 is true) to indicate successful completion of this sub-test. For this ground fault coil continuity self-test, if the ground fault secondary winding 18 is electrically continuous (i.e., not broken), then the response of the analog ground fault sensing circuit 34 to the self-test stimulus will be somewhat under-damped. In contrast, if the ground fault secondary winding 18 is not electrically continuous (i.e., broken), then the response of the analog ground fault sensing circuit 34 to the self-test stimulus will be critically damped. This difference in the circuit 34 response is employed to determine whether the ground fault secondary winding 18 is continuous or broken. If the test failed at 430 or 434, or after 428 or 436, then the case ends at 438.

If the test failed at 422 of FIG. 4B, then case 440 of FIG. 4C determines that the variable (self_test_state_counter) is four or three. If so, then at 442, it is determined if the variable (interrupt_counter) is two. If so, then as will be described in connection with FIGS. 4C and 4D, the line frequency current sensing (parallel arc fault) self-test applies a suitable stimulus to the analog line current sensing circuit 36 and verifies the corresponding transfer function by measuring the response. The PWM digital output 305 of the μP 66, which may also be employed to calibrate any line current offset, is varied to inject a signal that resembles a parallel arc fault. The μP 66, in turn, verifies that the response of the circuit 36 is correct. The line frequency current sensing (parallel arc fault) self-test is executed by determining, at 446, if the line-to-neutral voltage is positive (as was discussed above in connection with step 324 of FIG. 4A). If so, then a suitable offset (SELF_TEST_{—}60_HZ_STIMULUS) (e.g., without limitation, +2.1 V) is subtracted from an internal PWM register (pwm_duty_cycle) to simulate a positive polarity pulse on μP output 305 (FIGS. 1 and 2). The circuit 100 of FIG. 2 includes an inversion, which inverts the signal at the PWM output 305 to provide the positive polarity pulse. Otherwise, if the line-to-neutral voltage is negative at 446, then at 450, the suitable offset is added to the internal PWM register to simulate a negative polarity pulse on μP output 305 (FIGS. 1 and 2). Again, the circuit 100 of FIG. 2 includes an inversion, which inverts the signal at the PWM output 305 to provide the negative polarity pulse.

Otherwise, if the test failed at 442, then at 452, it is determined if the variable (interrupt_counter) is six. If so, then the stimulus for the line frequency current sensing (parallel arc fault) self-test is removed by removing any simulated current from the μP PWM output 305 (FIGS. 1 and 2) by providing a zero voltage output. If the test failed at 452, or after 448, 450 or 456, then the case ends at 458.

If the test failed at 440, then execution resumes at 460 of FIG. 4D where it is determined if the variable (self_test_state_counter) is two. If so, then at 464, it is determined if the variable (interrupt_counter) is two. If so, then the response of the line frequency current sensing (parallel arc fault) self-test is verified starting at 468. There, it is determined if the first simulated pulse (from either 448 or 450 of FIG. 4C) was correctly measured by the μP 66. This is determined if the absolute value of the corresponding peak current (i_peak(0)) is greater than a predetermined value (SELF_TEST_{—}60_HZ_RESULT) (e.g., without limitation, 1.66 V). If so, then at 470, the variable (self_test.passed_tests) is ORed with a predetermined value (SELF_TEST_BITMASK_AF_CURRENT_{—}0) (e.g., without limitation, 0b00010000 or only bit 4 is true) to indicate successful completion of this sub-test. Next, or if the test failed at 468, it is determined if the second simulated pulse (from either 450 or 448 of FIG. 4C) was correctly measured by the μP 66. This is determined if the absolute value of the corresponding peak current (i_peak(1)) is greater than the predetermined value (SELF_TEST_{—}60_HZ_RESULT). If so, then at 474, the variable (self_test.passed_tests) is ORed with a predetermined value (SELF_TEST_BITMASK_AF_CURRENT_{—}1) (e.g., without limitation, 0b00001000 or only bit 3 is true) to indicate successful completion of this sub-test.

If the test failed at 464, then at 476, it is determined if the variable (interrupt_counter) is three or five. If so, then the high frequency current sensing (series arc fault) self-test is executed by applying, at 480, simulated high frequency current pulses to the high frequency gain and filtering circuit 38 of FIG. 1. This includes a burst of about 20 pulses at about the specified resonant frequency of the sensing coil (e.g., without limitation, 1 MHz) from μP output (TEST_GF_HF) 335. These pulses are injected into the high frequency gain and filtering circuit 38. If the secondary winding 18 of the current sensor 14 is electrically continuous (i.e., not broken), then the net response of the circuit 38 will tend to be under-damped. In contrast, if this secondary winding 18 is not electrically continuous (i.e., broken), then the response of the circuit 38 will be critically damped. By measuring the amplitude of the resulting signal 48 generated by the circuit 38 and captured as signal 54 by the high frequency peak detector 50, the response of the circuit 38 is employed to determine whether secondary winding 18 is broken or not. In addition, the measurement can be used to determine whether the natural resonant frequency of the current sensor 14 is within certain tolerances.

If the test failed at 476, then the response of the high frequency current sensing (series arc fault) self-test is verified starting at 484. There, it is determined if the first high frequency peak detector self-test (from the stimulus at time 485 of FIG. 5) was successful by determining if the variable (interrupt_counter) is four and if the high frequency peak value (HF_peak) of peak signal 54 as measured from the ADC input 55 is greater than a predetermined value (SELF_TEST_HF_COIL_OKAY) (e.g., without limitation, +0.16 V). If so, then at 486, the variable (self_test.passed_tests) is ORed with a predetermined value (SELF_TEST_BITMASK_HF_PEAK_{—}4) (e.g., without limitation, 0b00000100 or only bit 2 is true) to indicate successful completion of this sub-test. If the test at 484 failed, then at 488, it is determined if the second high frequency peak detector self-test (from the stimulus at time 489 of FIG. 5) was successful by determining if the variable (interrupt_counter) is six and if the high frequency peak value (HF_peak) of peak signal 54 as measured from the ADC input 55 is greater than the predetermined value (SELF_TEST_HF_COIL_OKAY). If so, then at 490, the variable (self_test.passed_tests) is ORed with a predetermined value (SELF_TEST_BITMASK_HF_PEAK_{—}6) (e.g., without limitation, 0b00000010 or only bit 1 is true) to indicate successful completion of this sub-test. If the tests failed at 472 or 488, or after 474, 480, 486 or 490, then the case ends at 492.

If the test failed at 460, then execution resumes at 494 of FIG. 4E where it is determined if the variable (self_test_state_counter) is one. If so, then at 496, it is determined if the variable (interrupt_counter) is two. If so, then the response of the high frequency current pulse counter 64 of FIG. 1 (series arc fault) self-test is verified starting at 500. There, it is determined if the counter 64 properly detected the high frequency self-test by checking if the count (HF_count) is greater than a predetermined value (SELF_TEST_HF_COUNTER_OK) (e.g., without limitation, 1). If so, then at 502, the variable (self_test.passed_tests) is ORed with a predetermined value (SELF_TEST_BITMASK_HF_COUNT) (e.g., without limitation, 0b00000001 or only bit 0 is true) to indicate successful completion of this sub-test.

If the test failed at 496, then at 504, it is determined if the variable (interrupt_counter) is three. If so, then the self-test procedure is concluded by determining whether all portions of the self-test sequence have passed. This is determined, at 508, if the variable (self_test.passed_tests) is equal to a predetermined value (SELF_TEST_SUCCESSFUL) (e.g., without limitation, 0b11111111 or all bits 7-0 being set true) to indicate successful completion of all of the sub-tests. If so, then at 510, a variable (last cause of trip) is stored in non-volatile memory (e.g., without limitation, EEPROM 511 of FIG. 1) to indicate that the cause of the trip was the successful completion of the self-test. Next, at 512, the trip of the circuit interrupter 2 is requested. On the other hand, if the test failed at 508, then there was an unsuccessful completion of all of the sub-tests. If so, then at 514, the variable (self_test.passed_tests) is stored in another location in the non-volatile memory (e.g., without limitation, EEPROM 511 of FIG. 1) to indicate the failure of a number of portion(s) of the self-test.

As a result, if all aspects of the circuit interrupter hardware successfully meet their respective self-test criteria, then the μP 66 issues the trip signal 74 to trip the circuit interrupter 2. Otherwise, if any aspect of this hardware fails the corresponding self-test criteria, then the μP 66 does not issue the trip signal 74. In either case, the EEPROM 511 indicates either a trip due to the success of the self-test, or else the cause of the failure to trip as a result of the self-test, which is the failure of one or more of the various sub-tests.

If the tests failed at 500 or 504, or after 502, 512 or 514, then the case ends at 516. If the test failed at 494, then the switch of 400 of FIG. 4B ends at 518. Next, at 520, it is determined if the variable (self_test_state_counter) is greater than zero and the variable (interrupt_counter) is nine. If so, then at 522, the variable (self_test_state_counter) is decremented at 522. This causes that variable to be decremented once per half-cycle. If the test failed at 520, or after 522, the self-test routine 303 returns at 524.

As an alternative to the manual self-test request routine 200 of FIG. 3, FIG. 6 shows a routine 600 (for execution by the μP 66 of FIG. 1) to provide a periodic self-test request. At 602, the routine 600 is executed once per cycle of the (e.g., without limitation, 60 Hz) line-to-neutral voltage. Next, at 604, an automatic self-test initiation counter (automatic_selftest_initiation_count) is incremented. Next, at 606, it is determined if a predetermined time has elapsed since the last automatic self-test and that there is no pending trip request by checking if counter (automatic_selftest_initiation_count) is greater than a predetermined value (INITIATE_AUTOMATIC_SELFTEST_COUNT) (e.g., without limitation, 648,000, which corresponds to three hours in this example; a value, which corresponds to about 24 hours; any suitable value) and variable (trip_request) is not set. If so, then at 608, the variable (self_test_state_counter) is set to six, which is compatible with the main routine 300 and the interrupt routine 302 of FIG. 4A, and with the manually requested self-test routine 303 of FIGS. 4B-4E. Then, at 610, the automatic self-test initiation counter (automatic_selftest_initiation_count) is set to zero. After 610, or if the test failed at 606, the routine 600 ends at 612.

The periodic self-test request routine 600 of FIG. 6 functions with the routine 303 of FIGS. 4B-4E with one exception. This exception is shown by the portion of the routine 303′ of FIG. 7 to perform the periodically requested self-test. Steps 509′, 511′ and 512′ are used in place of steps 510, 512 and 514 of FIG. 4E. Otherwise, the routine 303′ is the same as the routine 303 of FIGS. 4B-4E and the circuit interrupter 2′ is the same, except for routines 303′ and 600, as the circuit interrupter 2 of FIG. 1. Step 508′ is also the same as step 508 of FIG. 4E and is provided to show the proper context of the routine 303′. If all of the self-tests pass successfully, as determined at 508′, then execution resumes at 516 of FIG. 4E. This does not trip the circuit interrupter 2′ and maintains the closed state of the separable contacts 4, does not store any value to EEPROM 511, and maintains an annunciator 510′ (FIG. 1) inactive.

On the other hand, if any number of the self-tests failed, then at 509′, a suitable annunciator 510′ (e.g., without limitation, a visible indicator, such as an LED, is illuminated; an audible indicator, such as a buzzer, is sounded) is set to indicate that there was a failure. Alternatively, a visible indicator, such as an LED, may normally be illuminated (when power is applied) and may be extinguished to indicate that there was a failure. Next, at 511′, the variable (self_test.passed_tests) of FIGS. 4B, 4D and 4E is stored in non-volatile memory (e.g., without limitation, EEPROM 511 of FIG. 1) to indicate that the cause of the trip was the unsuccessful completion of the self-test. Then, at 512′, the trip of the circuit interrupter 2′ is requested. Finally, execution resumes at 516 of FIG. 4E.

### EXAMPLE 1

The routine 303′ and the annunciator 510′ permit the circuit interrupter 2′ to trip with a suitable visual and/or audible indication and with the ability to be reset by the reset mechanism 9 a plurality of times. Preferably, the annunciator 510′ provides a continuous and permanent indication of any self-test failure. For example, if the annunciator 510′ is an LED, then the LED is permanently illuminated (when power is applied) after the first of any such self-test failure. Alternatively, if the LED is normally illuminated, then the LED is permanently extinguished after the first of any such self-test failure. This permits the user of the circuit interrupter 2′ to have sufficient time to make arrangements to replace an end-of-life circuit interrupter, with the knowledge that arc fault and/or ground fault protection has been lost. This is contrasted with complete and permanent removal of power (where a reset operation by the reset mechanism 9 is not permitted), which would require the user to reconnect critical loads to other power circuits with extension cords or by physically moving the load.

### EXAMPLE 2

The annunciator 510′ may include a first annunciator (e.g., without limitation, first LED) corresponding to the ground fault analog sensing circuit 34 and the current sensor 12, and a second annunciator (e.g., without limitation, second LED) corresponding to the arc fault analog sensing circuit 38 and the current sensor 14. Here, step 509′ sets the first LED responsive to failure of any number of the ground fault sub-tests, and sets the second LED responsive to failure of any number of the arc fault sub-tests.

### EXAMPLE 3

The disclosed arc fault/ground fault circuit interrupter 2 provides a background self-test function that is initiated periodically (FIG. 6) by the μP 66 rather than by the user pressing the test pushbutton 201.

An approach used for the combination (parallel arc fault/series arc fault detection) AFCI electronics is to test each critical analog sensing section for functionality and to use a ROM checksum of μC 42 to verify that the ROM (not shown) contents are correct. This is contrasted with a prior “complete system” self-test philosophy in analog ASIC-based parallel AFCIs and in GFCIs, in which a circuit simulates a fault condition that is detected by a fault detection algorithm, which trips the circuit interrupter.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A circuit interrupter comprising:
separable contacts;
a neutral conductor;
an operating mechanism structured to open and close said separable contacts;
at least one current sensor structured to sense at least current flowing through said separable contacts, each of said at least one current sensor comprising a primary winding and a secondary winding, said primary winding being electrically connected in series with said separable contacts;
a trip mechanism structured to cooperate with the secondary winding of said at least one current sensor and said operating mechanism to trip open said separable contacts; and
a test circuit for testing said at least one current sensor and said trip mechanism, said test circuit being structured to apply a test signal directly to the secondary winding of each of said at least one current sensor.

2. The circuit interrupter of claim 1 wherein said circuit interrupter is a ground fault circuit interrupter; and wherein said at least one current sensor is a current transformer structured to sense a difference between said current flowing through said separable contacts and a current flowing through said neutral conductor.

3. The circuit interrupter of claim 1 wherein said circuit interrupter is an arc fault circuit interrupter; wherein said current flowing through said separable contacts includes frequencies greater than about 100 kHz; and wherein said at least one current sensor is a current transformer structured to sense said current flowing through said separable contacts including said frequencies.

4. A circuit interrupter comprising:
separable contacts;
a neutral conductor;
an operating mechanism structured to open and close said separable contacts;
at least one current sensor structured to sense at least current flowing through said separable contacts;
a trip mechanism comprising at least one of a ground fault analog sensing circuit and an arc fault analog sensing circuit cooperating with said at least one current sensor, said trip mechanism being structured to cooperate with said at least one current sensor and said operating mechanism to trip open said separable contacts;
a reset mechanism structured to cooperate with said operating mechanism to close said separable contacts after said operating mechanism trips open said separable contacts;
at least one annunciator; and
a test circuit structured to periodically test said at least one current sensor and said at least one of the ground fault analog sensing circuit and the arc fault analog sensing circuit, to activate said at least one annunciator responsive to a failure of a periodic test and to cause said trip mechanism to cooperate with said operating mechanism to trip open said separable contacts responsive to said failure of said periodic test, and, otherwise, to maintain said at least one annunciator inactive and maintain said separable contacts being closed responsive to passage of said periodic test.

5. The circuit interrupter of claim 4 wherein said test circuit is further structured to permanently activate said at least one annunciator responsive to failure of said periodic test.

6. The circuit interrupter of claim 4 wherein said test circuit is further structured to periodically test said at least one current sensor and said at least one of the ground fault analog sensing circuit and the arc fault analog sensing circuit about once per day.

7. The circuit interrupter of claim 4 wherein said at least one annunciator is an audible indicator.

8. The circuit interrupter of claim 4 wherein said at least one annunciator is a visible indicator.

9. The circuit interrupter of claim 4 wherein said circuit interrupter is a ground fault circuit interrupter; and wherein said at least one current sensor is a current transformer structured to sense a difference between said current flowing through said separable contacts and a current flowing through said neutral conductor.

10. The circuit interrupter of claim 4 wherein said circuit interrupter is an arc fault circuit interrupter; and wherein said at least one current sensor is a current transformer structured to sense said current flowing through said separable contacts.

11. The circuit interrupter of claim 4 wherein said circuit interrupter is a ground fault/arc fault circuit interrupter; wherein said at least one current sensor comprises a first current transformer structured to sense a difference between said current flowing through said separable contacts and a current flowing through said neutral conductor, and a second current transformer structured to sense said current flowing through said separable contacts.

12. The circuit interrupter of claim 11 wherein said at least one annunciator is a first annunciator corresponding to said ground fault analog sensing circuit and said first current transformer, and a second annunciator corresponding to said arc fault analog sensing circuit and said second current transformer.

13. The circuit interrupter of claim 12 wherein said test circuit is further structured to periodically test both of said ground fault analog sensing circuit and said first current transformer, and said arc fault analog sensing circuit and said second current transformer; and wherein said test circuit is further structured to activate said first annunciator responsive to failure of a test of said ground fault analog sensing circuit and said first current transformer and to activate said second annunciator responsive to failure of a test of said arc fault analog sensing circuit and said second current transformer.

14. A circuit interrupter comprising:
separable contacts;
a neutral conductor;
an operating mechanism structured to open and close said separable contacts;
a first current sensor structured to sense a difference between a current flowing through said separable contacts and a current flowing through said neutral conductor;
a first analog sensing circuit cooperating with said first current sensor;
a second current sensor structured to sense current flowing through said separable contacts;
a second analog sensing circuit cooperating with said second current sensor;
a trip mechanism comprising a ground fault detector cooperating with said first analog sensing circuit and an arc fault detector cooperating with said second analog sensing circuit, said trip mechanism being structured to cooperate with said first analog sensing circuit, said second analog sensing circuit and said operating mechanism to trip open said separable contacts; and
a test circuit structured to provide both of a first test of said first current sensor and said first analog sensing circuit and a second test of said second current sensor and said second analog sensing circuit, and to cause said trip mechanism to cooperate with said operating mechanism to trip open said separable contacts responsive to failure of at least one of said first test and said second test, and, otherwise, to maintain said separable contacts being closed responsive to passage of both of said first test and said second test,
wherein said first current sensor and said first analog sensing circuit have a first transfer function,
wherein said second current sensor and said second analog sensing circuit have a second transfer function, and
wherein said test circuit is further structured to provide a first test signal to said first current sensor and said first analog sensing circuit to test said first transfer function without causing a ground fault to be detected by said ground fault detector, and a second test signal to said second current sensor and said second analog sensing circuit to test said second transfer function without causing an arc fault to be detected by said arc fault detector, in order to provide both of said first test and said second test before causing said trip mechanism to cooperate with said operating mechanism to trip open said separable contacts.

15. The circuit interrupter of claim 14 wherein said current flowing through said separable contacts has a first frequency; wherein said first test signal has a second frequency, which is one-half of said first frequency; and wherein said test circuit is further structured to input a first signal from said first analog sensing circuit and determine if said first signal is less than a negative predetermined value in order to pass said first test.

16. The circuit interrupter of claim 15 wherein said first current sensor is a current transformer including a coil; and wherein said test circuit is further structured to input a second signal from said first analog sensing circuit and determine if said second signal is greater than a positive predetermined value in order to confirm that said coil is continuous and to pass said first test.

17. The circuit interrupter of claim 14 wherein said current flowing through said separable contacts has a first line frequency; wherein said second test signal has a second frequency, which is substantially greater than said first line frequency and which is greater than about 100 kHz; and wherein said test circuit is further structured to input a third signal from said second analog sensing circuit and determine if said third signal is greater than a positive predetermined value in order to pass said second test.

18. The circuit interrupter of claim 17 wherein said second current sensor is a current transformer structured to sense said current flowing through said separable contacts including said second frequency.

19. The circuit interrupter of claim 18 wherein said current transformer is further structured to resonate in response to said second frequency.

20. A circuit interrupter comprising:
separable contacts;
a neutral conductor;
an operating mechanism structured to open and close said separable contacts;
a first current sensor structured to sense a difference between a current flowing through said separable contacts and a current flowing through said neutral conductor;
a first analog sensing circuit cooperating with said first current sensor;
a second current sensor structured to sense current flowing through said separable contacts;
a second analog sensing circuit cooperating with said second current sensor;
a third current sensor structured to sense current flowing through said separable contacts;
a third analog sensing circuit cooperating with said third current sensor;
a trip mechanism comprising a ground fault detector, a parallel arc fault detector and a series arc fault detector;
a test pushbutton; and
a test circuit structured to provide all of (i) a first test of said first current sensor and said first analog sensing circuit, (ii) a second test of said second current sensor and said second analog sensing circuit, and (iii) a third test of said third current sensor and said third analog sensing circuit, to cause said trip mechanism to cooperate with said operating mechanism to trip open said separable contacts responsive to passage of all of said first test, said second test and said third test, and, otherwise, to maintain said separable contacts being closed responsive to failure of at least one of said first test, said second test and said third test.
